(19) United States
(12) Patent Application Publication
(10) Pub. No.: US 2009/0295655 A1
(43) Pub. Date: Dec. 3, 2009

(54) Planar antenna, communication apparatus and mounting method of planar antenna

(75) Inventors: Kiyokazu Akiyama, Okazaki-city (JP); Yuji Sugimoto, Kariya-city (JP); Taizo Mizutani, Nagoya-city (JP); Michio Shamoto, Konan-city (JP)

Correspondence Address: HARNESS, DICKEY & PIERCE, P.L.C., P.O. BOX 828, BLOOMFIELD HILLS, MI, 48303, US

(73) Assignees: DENSO CORPORATION, Kariya-city (JP); Nippon Soken, Inc., Nishio-city (JP)

(21) Appl. No.: 12/454,419

(22) Filed: May 18, 2009

(30) Foreign Application Priority Data
May 28, 2008 (JP) 2008-139522

(51) Int. Cl. H01Q 9/04; H01Q 19/00; H01Q 1/32

(52) U.S. Cl. 343/713; 343/833; 343/700 MS

(57) ABSTRACT

A planar antenna is disclosed. The planar antenna includes: a radiator element having a wideband resonant characteristic; and a parasitic element having a planar shape. The parasitic element has a first side, a second side, a third side and a fourth side. Each of the first side and the second side is parallel to a direction of an electric current to be excited in the radiator element. The first side is located closer to the radiator element than the second side is. The first side is shorter than the second side. The third side connects one ends of the first side and the second side. The fourth side connects the other ends of the first side and the second side. A region between the third and fourth sides tapers in a direction from the second side toward the first side.

### CROSS REFERENCE TO RELATED APPLICATION

The present application is based on Japanese Patent Application No. 2008-139522 filed on May 28, 2008, the disclosure of which is incorporated herein by reference.

### BACKGROUND OF THE INVENTION

1. Field of the Invention

The present invention relates to a planar antenna, a communication apparatus and a mounting method of a planar antenna.

2. Description of Related Art

There is known a wideband antenna that is formed in a planar shape using a conductor pattern on a printed circuit board (cf. JP-A-2006-345038).

The wideband antenna disclosed in JP-A-2006-345038 has omni-directivity in a plane parallel to the conductor pattern. The inventors however consider that it may be preferable that such a wide-band antenna have directivity in a plane parallel to a conductor pattern. Further, it may be preferable that a planar antenna configuration for providing directivity do not spoil compactness of a planar antenna.

### SUMMARY OF THE INVENTION

In view of the above and other points, it is an objective of the present invention to provide a planar antenna, a communication apparatus, and a mounting method.

According to a first aspect of the present invention, a planar antenna is provided. The planar antenna includes a radiator element having a wideband resonant characteristic and a parasitic element having a planar shape. The parasitic element has a first side, a second side, a third side and a fourth side. Which of the first side and the second side is parallel to a reference axis, which extends in direction of an electric current to be excited in the radiator element. The first side is located closer to the radiator element than the second side is. A length of the first side is shorter than that of the second side. The third side connects one end of the first side and that of the second side. The fourth side connects the other end of the first side and that of the second side. A region of the parasitic element between the third side and the fourth side tapers in a direction from the second side toward the first side.

According to the above configuration, the planar antenna can have directivity and compactness.

According to a second aspect of the present invention, a communication apparatus is provided. The communication apparatus includes a planar antenna according to the first aspect and a control device that controls power feeding to the planar antenna.

According to the above configuration, it is possible to provide the communication apparatus having the planar antenna with directivity and compactness.

According to a third aspect of the present invention, a mounting method of a planar antenna according to the first aspect is provided. The mounting method includes: preparing a planar antenna according to claim 1; and mounting the planar antenna into a vehicle such that a vector having an initial point at the radiator element and a terminal point at the parasitic element is directed toward a vehicle compartment of the vehicle.

According to the above mounting method, it becomes easier to secure a mounting place for the planar antenna.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram illustrating a configuration of a planar antenna in accordance with one embodiment;

FIG. 2 is a diagram illustrating a planer antenna mounted in a vehicle;

FIG. 3 is a diagram illustrating dimensions of parts of a planar antenna;

FIG. 4 is a diagram illustrating a configuration and dimensions of a planar antenna in accordance with a comparison example;

FIG. 5 is a graph showing directivity of a planar antenna illustrated in FIG. 3; and

FIG. 6 is a graph showing directivity of a planar antenna illustrated in FIG. 4.

### DETAILED DESCRIPTION OF THE EXEMPLARY EMBODIMENTS

Exemplary embodiments are described below with reference to the accompanying drawings.

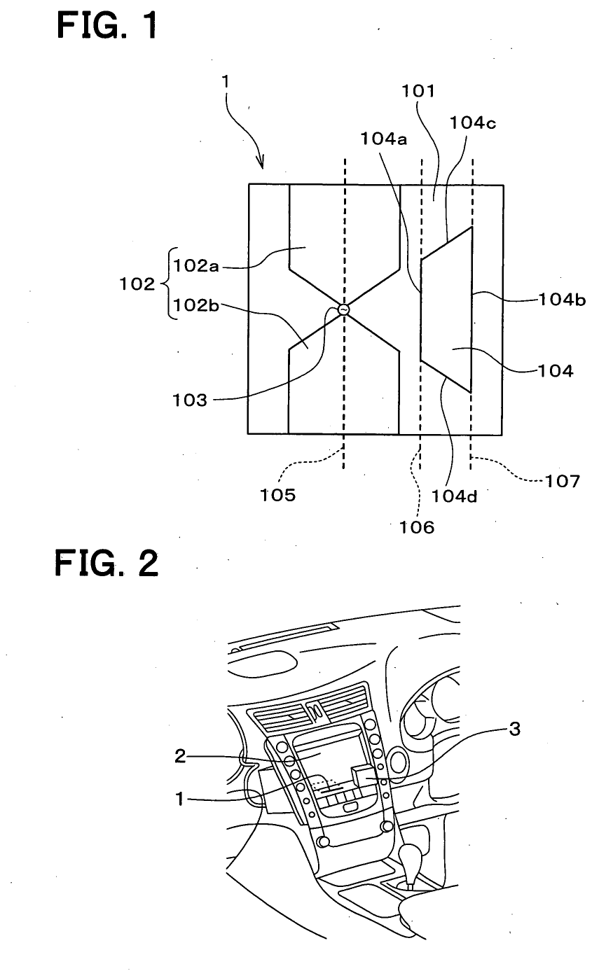

FIG. 1 is a diagram illustrating a planar antenna 1 in accordance with one embodiment. The planar antenna 1 can be mounted in a vehicle, and can be used for an in-vehicle apparatus (e.g., in-vehicle navigation apparatus) to wirelessly communicate with a communication device existing in a vehicle compartment. Such a communication device may be a cellular phone, a personal digital assistant (PDA), a radio frequency identification tag, or the like.

As shown in FIG. 1, the planar antenna 1 includes a printed circuit board 101 with a rectangular shape, which may be almost square. The planar antenna 1 further includes a radiator element 102 and a parasitic element 104, which are located on one surface of the printed circuit board 101 and are formed using a patterning method.

The radiator element 102 includes a conductor element 102a and a conductor element 102b, which are planar and extend in opposite directions from a feeding point 103. When a control apparatus (not shown) supplies an electric current to the feeding point 103, the radiator element 102 can function as a dipole antenna. The control apparatus includes a radio circuit. Under control of the in-vehicle apparatus, the radio circuit controls power feeding to the feeding point 103 by amplification, frequency conversion, modulation, demodulation or the like.

Each of the elements 102a, 102b is pentagonal, which shape may be illustrated as a shape of a home base used in base ball. A vertex of the element 102a and that of the 102b are located at the feeding point 103, from which the elements 102a and 102b extend in opposite directions. Each of the elements 102a, 102b has such a width and a length that enable the element 102a, 102b to have a director characteristic over a wide usable frequency band and a wideband resonant characteristic.

For example, the width and the length of each element 102a, 102b may be arranged so that the element 102a, 102b can have a director characteristic over a low band (e.g., between 3.1 GHz and 4.8 GHz) of ultra-wideband (UWB). Alternatively, the width and the length of each of the element 102a, 102b may be arranged so that the element 102a, 102b can have a director characteristic over a high hand (e.g., between 7 GHz and 10.6 GHz) of the UWB.

Herein, the length of the element 102a, 102b is measured along a first reference axis 105, which passes through the feeding point 103 and is parallel to a direction of an electric current to be excited in the element 102a, 102b due to power feeding from the feeding point 103. In FIG. 1, the first reference axis 105 is illustrated parallel to a lower-to-upper direction and is illustrated as a dashed line 105. The width of the element 102a, 102b is measured along a direction perpendicular to the first reference axis 105. The width direction of the element 102a, 102b corresponds to a left-to-right direction in the FIG. 1.

The parasitic element 104 is planar and pentagonal. The parasitic element 104 is located on one side of the first reference axis 105. For example, the parasitic element 104 may be located at a predetermined distance from the feeding point 103 in a direction perpendicular to the first reference axis 105. In FIG. 1, the parasitic element 104 is illustratively located on a right side of the first reference axis 105. The parasitic element 104 and the radiator element 102 are insulated from each other against a direct current. The parasitic element 104 has a trapezoidal perimeter, an inside of which is filled with a conductor. In other words, the parasitic element 104 does not have a hole.

Among the sides of the parasitic element 104 with the trapezoidal shape, a shorter side 104a of two parallel sides is located closest to the radiator element 102. Further, the shorter side 104a extends along a second reference axis 106, which is parallel to the first reference axis 105.

Among the sides of the parasitic element 104, a longer side 104b of the two parallel sides is located most distant from the radiator element 102. Further, the longer side 104b extends along a third reference axis 107, which is parallel to the first reference axis 105.

A side 104c of the parasitic element 104 connects one end of the longer side 104b and that of the shorter side 104a. A side 104d of the parasitic element 104 connects the other end of the longer side 104b and that of the shorter side 104a. In FIG. 1, the side 104c and the side 104d are respectively illustrated as an upper side and a lower side of the parasitic element 104. The sides 104c and 104d extend from the longer side 104b to the shorter side 104a so as to form a tapered shape. In other words, a region of the parasitic element 104 between the sides 104c and 104d tapers in a direction from the longer side 104b toward the shorter side 104a. The shorter side 104a, the longer side 104b, the side 104c and the side 104d of the parasitic element 104 may be also referred to herein as a first side, a second side, a third side, a fourth side, respectively

A length of the shorter side 104a and a location of the shorter side 104a relative to the radiator element 102 are arranged so that the parasitic element 104 can function as a director at an upper-limit frequency of the usable frequency band of the radiator element 102. The location of the shorter side 104a relative to the radiator element 102 is for example a distance to the radiator element 102 from the shorter side 104a.

Once the usable frequency band and a configuration (e.g., dielectric constant, dimension etc.) of the planar antenna 1 is pre-specified, it is possible to determine the length of the shorter side 104a and the location of the shorter side 104a relative to the radiator element 102 which enable the parasitic element 104 to function as a director at the upper-limit frequency of the usable frequency band of the radiator element 102.

It should be noted that a parasitic element can function as a director when the parasitic element is located at a distance of αλ/4 from a radiator element and when a length of the parasitic element is slightly smaller than that of the radiator element. In the above-described notations, λ is a wavelength of a usage radio wave, and α is a wavelength shorting ratio, which expresses an effect of a dielectric material of the printed circuit board.

A length of the longer side 104b and a location of the longer side 104b relative to the radiator element 102 are arranged so that the parasitic element 104 can function as a director at a lower-limit frequency of the usable frequency band of the radiator element 102. The location of the longer side 104b relative to the radiator element 102 is for example a distance to the radiator element 102 from the longer side 104b.

Once the usable frequency band and the configuration (e.g., dielectric constant, dimension etc.) of the planar antenna 1 is pre-specified, it is possible to determine the length of the longer side 104b and the location of the longer side 104b relative to the radiator element 102 which enable the parasitic element 104 to function as a director at the lower-limit frequency of the usable frequency band of the radiator element 102.

Explanation is given below on operation of the planar antenna 1.

When the control apparatus supplies power to the feeding point 103 in order to activate wireless communication at a certain frequency in the usable frequency band, the electric current is excited in the radiator element 102. Accordingly, an electric current is excited in the parasitic element 104 in a direction parallel to the first reference axis 105.

In the parasitic element 104, a length in a direction parallel to the first reference axis 105 continuously changes from the length of the shorter side 104a to that of the longer side 104b. Thus, for any frequency in the usable frequency band of the radiator element 102, the parasitic element 104 can function as a director at a corresponding portion between the shorter side 104a and the longer side 104b.

As a result, over the wide usable frequency band of the planar antenna 1, the planar antenna 1 can have directivity in a direction parallel to the surface of the printed circuit board. More specifically, the planar antenna 1 can have directivity in a direction from the radiator element 102 to the parasitic element 104.

Thus, it is possible to provide desirable directivity over the usable frequency band of the radiator element 102. Further, the parasitic element 104 providing the directivity is also planar as the radiator element 102 is, and therefore, the planar antenna 1 can have compactness and can save space.

FIG. 2 is a diagram associated with mounting the planar antenna 1 in a vehicle. As described above, the planar antenna 1 has directivity in a direction parallel to the surface of the printed circuit board 101. Accordingly, the planar antenna 1 can be mounted so that a side face of the planar antenna 1 is directed toward a vehicle compartment. More specifically, the planar antenna 1 can be mounted so that the a vector having an initial point at the radiator element 102 and a terminal point at the parasitic element 104 is directed toward the vehicle compartment.

As shown in FIG. 2, the planar antenna 1 may be placed in a gap formed below an image display apparatus 2 received in a center console of the vehicle.

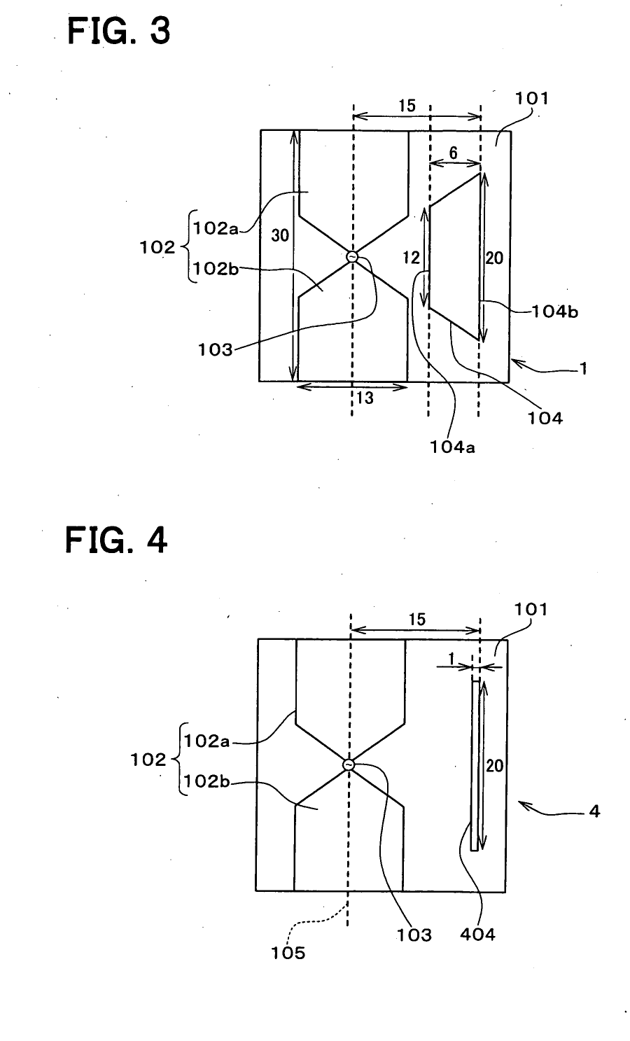

As described above, a direction normal to the surface of the printed circuit board 101 of the planar antenna 1 is perpendicular to the vector directed toward the vehicle compartment. Thus, an apparent area of the planar antenna 1 viewed from the vehicle compartment becomes smaller compared to a case where the surface of the printed circuit board 101 of the planar antenna 1 is directed toward the vehicle compartment as illustrated in FIG. 3 as the reference numeral 3. Therefore, it becomes easier to secure a mounting place for the planar antenna 1.

The inventors have carried out simulations for showing directivity and wideband characteristics of a planar antenna 1. Results of simulations are given blow on a case where a low band (e.g., frequency range between 3.1 GHz to 4.8 GHz and wavelength range between 96.8 mm and 62.5 mm) of the UWB is used as the usable frequency band. Comparison examples are also given below.

FIG. 3 shows dimensions of parts of the planar antenna 1 employed in the simulations, where figures of the dimensions have millimeter unit. In the simulations, a thickness of the printed circuit board 101 is set to 0.8 mm, and the dielectric constant of the printed circuit board is set to 4.9.

As shown in FIG. 3, the distance from the radiator element 102 to the shorter side 104a is set to 9 mm. More specifically, a distance from a center of the radiator element 102 to the shorter side 104a is set to 9 mm in a direction perpendicular to the first reference axis 105. The length of the shorter side 104a is set to 12 mm. It should be noted that the above described figures of the dimensions are to be understood as an example of the arrangement which enable the parasitic element 104 to function as a director at an upper limit frequency 4.8 GHz at the low band.

Further, the distance from the radiator element 102 to the longer side 104b is set to 15 mm. More specifically, a distance from the center of the radiator element 102 to the longer side 104b is set to 15 mm in the direction perpendicular to the first reference axis 105. The length of the longer side 104b is set to 20 mm. It should be noted that the above described figures of the dimensions is to be understood as an example of the arrangement which enable the parasitic element 104 to function as a director at a lower limit frequency 3.1 GHz of the low band.

FIG. 4 is a diagram illustrating a configuration and dimensions of a planer antenna 4 according to a comparison example. Between FIG. 1 and FIG. 4, like numeral references are used to refer like parts. In the planer antenna 4 of the comparison example, a parasitic element 404 has a slim linear shape, and thus, the parasitic element 404 can function as a director only in a predetermined narrow frequency band.

More specifically, for a radio-wave with a frequency of 3432 MHz corresponding to a wavelength λ=87.4 mm, a length of the parasitic element 404 is set to 0.28 αλ corresponding to 20 mm, and a distance from the radiator element 102 to the parasitic element 404 is set to 0.21 αλ corresponding to 15 mm, where α is a wavelength shorting ratio expressing an effect of a dielectric maternal of the printed circuit board 101.

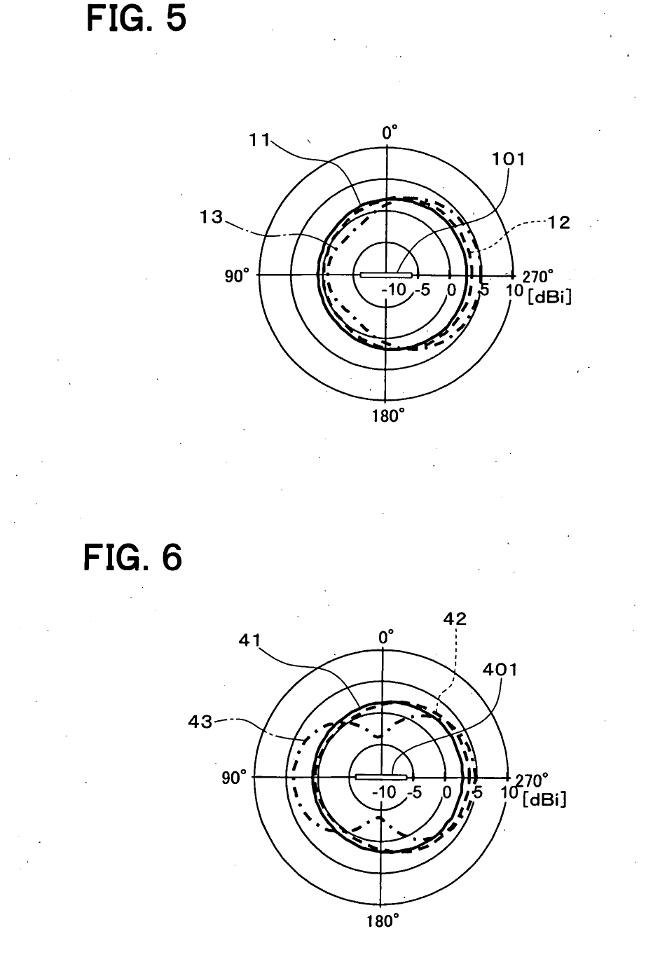

FIGS. 5 and 6 are graphs respectively showing simulation results and illustrating radiation intensities of the planer antennas 1 and 4. The graph shows the radiation intensity in a plane passing through the feeding point 103 and perpendicular to the first reference axis 105, which is parallel to the direction of the electric current excited in the radiator element 102. Further, in the graphs, a 0 degree direction corresponds to a direction normal to the print surface of the printed circuit board 101, and a 270 degrees direction corresponds to a direction from the radiator element 102 toward the parasitic element 104.

In FIG. 5, a solid line 11 shows a result of simulation in which an employed frequency is a central frequency of F1 band (3432±264 MHz), where the F1 band is one of three channels of a low band of the UWB. A dashed line 12 shows a result of simulation in which an employed frequency is a central frequency of F2 band (3960±264 MHz). A dashed-dotted line 13 shows a result of simulation in which an employed frequency is a central frequency of F3 band (4488±264 MHz).

As shown by the lines 11 to 13, the planar antenna 1 exemplified in FIG. 3 has directivity from the radiator element 102 to the parasitic element over all of the three channels of the low band.

In FIG. 6, the solid line 41 shows a result of simulation in which an employed frequency is a central frequency of the F1 channel of the low band. The dashed line 42 shows a result of simulation in which an employed frequency is a central frequency of the F2 channel of the low band. The dashed-dotted line 43 shows a result of simulation in which an employed frequency is a central frequency of the F1 channel of the low band.

As shown by the lines 41 to 43, the planar antenna 4 exemplified in FIG. 3 has directivity from the radiator element 102 to the parasitic element in F2 band and F3 band but does not have remarkable directivity in F3 band.

According to the above embodiment, the planar antenna 1 functions as a wideband antenna, which can be used for UWB communication and has a fractional band width of 25% or more, or a bandwidth of 1.5 GHz or more.

(Modifications)

The above-described embodiments can be modified in various ways.

For example, the tapered side 104c, 104d may be in the form of a straight line or a curved line. In other words, when a region of the parasitic element 104 defined between the tapered sides 104c and 104d tapers from the longer side 104b toward the shorter side 104a, a shape of the tapered side 104c, 104d may not matter. Further, the planar antenna 1 may not be mounted in a vehicle but may be applied to other devices. Further, the radiation element 102 may not function as a dipole antenna but may be configured to function as other antennas.

In the above embodiments, the usable frequency band may be determined based on a configuration of the radiator element 102 in some cases: Alternatively, the frequency band may be determined based on an operational manner of the control apparatus for supplying power to the radiator element.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments.

What is claimed is:

1. A planar antenna comprising:
a radiator element having a wideband resonant characteristic; and
a parasitic element having a planar shape, the parasitic element having a first side, a second side, a third side and a fourth side,
wherein:
each of the first side and the second side is parallel to a reference axis, which extends in direction of an electric current to be excited in the radiator element;
the first side is located closer to the radiator element than the second side is;
a length of the first side is shorter than that of the second side;
the third side connects one end of the first side and that of the second side;
the fourth side connects the other end of the first side and that of the second side; and
a region of the parasitic element between the third side and the fourth side tapers in a direction from the second side toward the first side.

2. The planar antenna according to claim 1, wherein:
the length of the first side and a location of the first side relative to the radiator element are arranged so that the parasitic element functions as a director at an upper-limit frequency of a usable frequency band of the radiator element; and
the length of the second side and a location of the second side relative to the radiator element are arranged so that the parasitic element functions as the director at a lower limit frequency of the usable frequency band of the radiator element.

3. The planar antenna according to claim 1,
wherein the planar antenna is mounted into a vehicle such that a vector having an initial point at the radiator element and a terminal point at the parasitic element is directed toward a vehicle compartment of the vehicle.

4. A communication apparatus comprising:
a planar antenna according to claim 1; and
a control device that controls power feeding to the planar antenna.

5. A mounting method comprising:
preparing a planar antenna according to claim 1; and
mounting the planar antenna into a vehicle such that a vector having an initial point at the radiator element and a terminal point at the parasitic element is directed toward a vehicle compartment of the vehicle.

6. The planar antenna according to claim 2, further comprising:
a printed circuit board having a first surface,
wherein each of the radiator element and the parasitic element is in a form of a conductor pattern on the first surface of the printed circuit board;
